(19) United States
(12) Patent Application Publication
(10) Pub. No.: US 2014/0053341 A1
(43) Pub. Date: Feb. 27, 2014

(54) FOAM FIBER STRUCTURE AND METHOD OF MAKING SAME

(71) Applicant: Sleep Innovations, Inc., West Long Branch, NJ (US)

(72) Inventor: Eddie Lee Parvin, Corinth, MS (US)

(73) Assignee: Sleep Innovations, Inc., West Long Branch, NJ (US)

(21) Appl. No.: 14/011,362

(22) Filed: Aug. 27, 2013

Related U.S. Application Data
(60) Provisional application No. 61/693,520, filed on Aug. 27, 2012.

(51) Int. Cl. B32B 3/28; B32B 5/24; A47G 9/10; B29D 99/00; A47C 7/40

(52) U.S. Cl. CPC B32B 3/28; B29D 99/0092; A47C 7/40; A47G 9/10; B32B 5/245
USPC 5/740; 264/45.1; 5/655.9; 297/452.48; 297/461; 428/181

(57) ABSTRACT

A foam fiber product may be used for the manufacture of various bedding products, such as mattresses, pillows, mattress toppers, seat cushions, and the like. The foam fiber product includes foam particles dispersed with fiber strands. The pleats provide extra support and durability to the structure of the foam fiber product. The product may be made by a process that includes mixing foam particles with fiber strands, processing the mixture into a layer using processes such as garnetting and carding, using a vertical lapping process to form pleats in the layer, and heating the structure to secure the pleats together to provide a pleated foam fiber structure.

### RELATED APPLICATIONS AND CLAIM OF PRIORITY

This patent document claims priority to U.S. Provisional Patent Application No. 61/693,520, filed Aug. 27, 2012. The disclosure of the provisional application is incorporated herein by referenced in its entirety.

### BACKGROUND

Fiber, in various forms, combinations, and densities, is commonly used in various bedding products, including, mattresses, pillows, mattress toppers, seat cushions, and similar products. Foam can also be used in bedding products and is desirable in its ability to mold to the contour of a person, while providing support and cushioning, and then return to its original shape after weight is removed.

Fiber and foam are not traditionally combined into products. For example, manufacturers of fiber products typically do not deal with foam materials, while foam product manufacturers likewise do not utilize fiber in their products.

The production of various products, including bedding products, results in scraps of materials. These scraps of materials typically go unused and are discarded. It is desirable to utilize excess scrap materials, including excess scrap foam, in a manner that improves the performance and utility of bedding products.

### SUMMARY

In various embodiments, a method of forming a foam fiber product includes distributing foam particles with fiber to produce a foam fiber mixture, and applying a fiber layer construction process to the foam fiber mixture to form a foam fiber structure comprising a plurality of pleats. The fiber layer construction process may include applying a first lapping process to the mixture to form one or more lapped layers of foam fiber materials, processing the lapped layers by a carding machine to align the fibers in a foam fiber layer, and applying a vertical lap fiber process to form the lapped layers into the pleated structure. The fiber may include low melt fiber strands and high melt fiber strands, and the method also may include applying heat to the structure at a temperature that is above a melting point of the low melt fibers and below a melting point of the high melt fibers. In this way, low melt fibers become tacky and bind the pleated structure together.

The method also may include binding the structure with one or more additional foam fiber pleated structures to form a thickened foam fiber product, and/or bonding a supporting layer to a base portion of the pleated foam fiber structure

In this way the method may create a foam fiber product that includes a sheet comprising foam particles distributed with fibers formed as a plurality of pleats extending from a top portion to a bottom portion of the sheet. The pleats may extend nearly perpendicularly from the top portion to the bottom portion.

The foam particles may include, for example, gel foam, viscoelastic foam, polyurethane foam, memory foam, slow recovery foam, ground foam, latex foam, reflex foam, continuous foam, hyper-soft resilient foam, and/or hyper-soft high airflow viscoelastic foam. The fiber may include, for example, polypropylene, rubberized fiber, rayon, nylon, polyethylene, and/or cotton. The foam fiber product may include about 20% to about 30% by volume of foam and about 70% to about 80% by volume of fiber.

For example, a bedding product may include a pleated layer structure comprising a mixture of foam and fiber strands. Optionally, the bedding product may include a non-foam-fiber layer attached to the pleated layer structure. Examples of suitable bedding products include a mattress, pillow, lumbar support, back support, gaming chair, ottoman, or a chair pad.

### BRIEF DESCRIPTION OF THE DRAWINGS

FIG. 1A is a diagram illustrating a perspective view of a structure of a foam fiber product, according to an embodiment.

FIG. 1B is a diagram illustrating a partial front view of the structure of a foam fiber product, according to an embodiment.

FIG. 2 is a diagram of a system used to make a foam fiber product, according to an embodiment.

FIG. 3 is a flow chart illustrating a method of making a foam fiber product, according to an embodiment.

FIGS. 4A and 4B are diagrams illustrating a perspective view of a structure of a thickened foam fiber product, according to embodiments.

FIGS. 5A, 5B, 5C, and 5D are diagrams illustrating perspective views of a structure incorporating a foam fiber product with other products, according to additional embodiments.

### DETAILED DESCRIPTION

As used in this document, the singular forms “a”, “an”, and “the” include the plural reference unless the context clearly dictates otherwise. Thus, for example, reference to a “gel” is a reference to one or more gels and equivalents thereof known to those skilled in the art, and so forth.

As used in this document, the term “about” means plus or minus 10% of the numerical value of the number with which it is being used. Therefore, about 50% means in the range of 45% to 55%.

As used in this document, the term “foam fiber” means a material formed of a mixture of foam particles and fiber strands. The term “gel-foam” means a foam comprising a gel dispersed within.

In embodiments, foam particles are distributed within fiber, and/or fibrous materials are distributed within a foam to form a foam fiber product. A foam particle refers to a piece of foam which may take the form of a sphere, a cube, a cylinder, an irregular shape or another shape. The foam particles may be portions or pieces of excess scrap foam from other processes or applications, or, in other embodiments, the foam particles may be portions or pieces of new foam. The foam may be shredded into the foam particles, and may accordingly be of varying and irregular shapes. Use of excess scrap foam into a new product (i.e., the foam fiber product) reduces the expense and inconvenience of getting rid of the scrap foam, while simultaneously creating a recycled product. A benefit of incorporating the foam particles with the fiber is that the resulting product has a resilient, memory foam-like quality that is not achieved by fiber alone, while the fiber provides structural support for the foam.

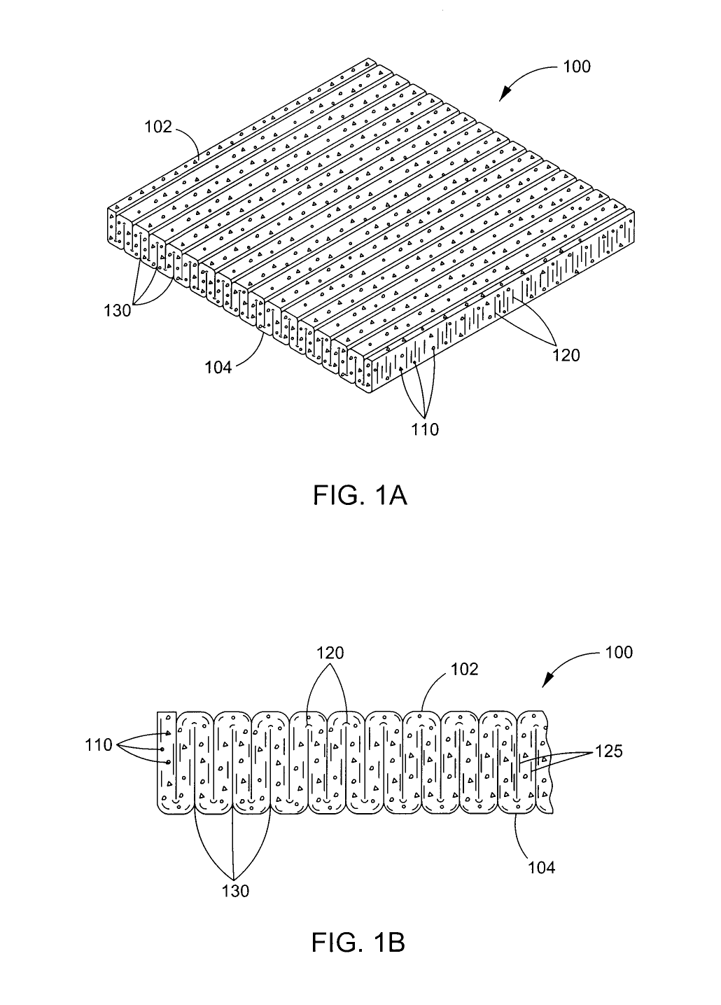

FIG. 1A is a diagram providing a perspective view of a structure of a foam fiber product 100 that can be used to provide support and cushioning in various products, such as mattresses, pillows, mattress toppers, seat cushions, and the like. FIG. 1B is a diagram illustrating a front view of the foam fiber product 100. The foam fiber product 100 is a sheet made up of foam particles 110 intermixed with a fibrous material 120. The fiber 120 may be comprised of a plurality of fiber strands 125. In some embodiments, the fiber strands 125 may be arranged such that the fibers in the vertically-oriented portions of the pleats parallel or nearly parallel with respect to one another (see FIG. 1B). The distribution of the foam particles 110 with the fiber 120 may be evenly or nearly evenly distributed, although by nature of the dispersion and distribution process, described below, some variation in the distribution of the foam particles 110 and the fiber strands 125 may exist.

As shown in the embodiments of FIGS. 1A and 1B, the structure of the foam fiber product 100 may be a generally planar sheet comprising a series of pleats 130 corrugated between a top portion 102 and a bottom portion 104 of the structure 100. As shown, the series of pleats 130 are a series of folds formed into the structure 100, with the pleats 130, according to one embodiment, extending perpendicularly or near perpendicularly between the top and bottom portions 102, 104. Thus, the structure 100 may be considered a foam-fiber layer. In some embodiments, the fiber stands 125 of the fiber 120 extend perpendicularly or near perpendicularly in an accordion-like fashion between the top and bottom portions 102, 104 (i.e., the fiber strands 125 are folded to form the pleats 130). According to an embodiment, the series of pleats 130 may be slightly skewed away from a perpendicular orientation with respect to the top and bottom portions 102, 104. For example, the series of pleats 130 may be skewed up to around 30 degrees from the perpendicular orientation with respect to the top and bottom portions 102, 104.

The pleats 130 provide extra support and durability to the structure of the foam fiber product 100, resulting in less body impression from a person or object utilizing a product comprised of the foam fiber product 100. The density or thickness of the pleats 130 may vary depending on the composition of the foam particles 110 and the fiber 120, and the intended application or use of the foam fiber product 100. Some products may, for example, be better suited for tightly compressed pleats 130, while other products may require the pleats 130 to be spaced further apart. In general, tightly compressed pleats 130 result in a firmer structure than pleats 130 that are spread further apart from one another.

According to embodiments, the combination of the foam particles 110 and the fiber 120 may include various percentages of the materials, according to the intended application or use of the foam fiber product 100. The fiber 120 may be one or more of various natural or synthetic materials such as polyester, polypropylene, rayon, nylon, polyethylene, cotton, and any combination thereof. For example, according to an embodiment, the fiber is a mixture of about 20% to about 45%, by volume, of low melt fibers and about 55% to about 80%, by volume, of other fibers, wherein the total percentage by volume equals 100%. In another embodiment, the fiber is a mixture of about 20% to about 30%, by volume, of low melt fibers and about 70% to about 80%, by volume, of other fibers, wherein the total percentage by volume equals 100%. According to another embodiment, the foam fiber product 100 is comprised of about 20%, by volume, viscoelastic foam particles and about 80%, by volume, fiber, where the fiber is a mixture of about 20%, by volume, of low melt fibers and about 80%, by volume, of other fibers. According to yet another embodiment, the foam fiber product 100 is comprised of about 30%, by volume, viscoelastic foam particles and about 70%, by volume, fiber, where the fiber is a mixture of about 20%, by volume, of low melt fibers and about 80%, by volume, of other fibers. Low melt fibers are those that typically become tacky (e.g. sticky) or melt at lower temperatures than other fibers in the structure. According to an embodiment, the low melt fibers include a hot melt coating on the fibers that becomes tacky or melts upon exposure to heat. Melting the hot melt coating can result in a reduction in the denier for the low melt fibers. Examples of low melt polyesters may become tacky at 220 to 420° F., as compared to standard polyesters which may not begin to melt until temperatures reach 482 to 550° F. Such temperature ranges are typically below ranges likely to degrade any foam components. This is just one example; the foam fiber product 100 is not limited to such a composition, and any composition of foam particles 110 and fiber 120 may be used.

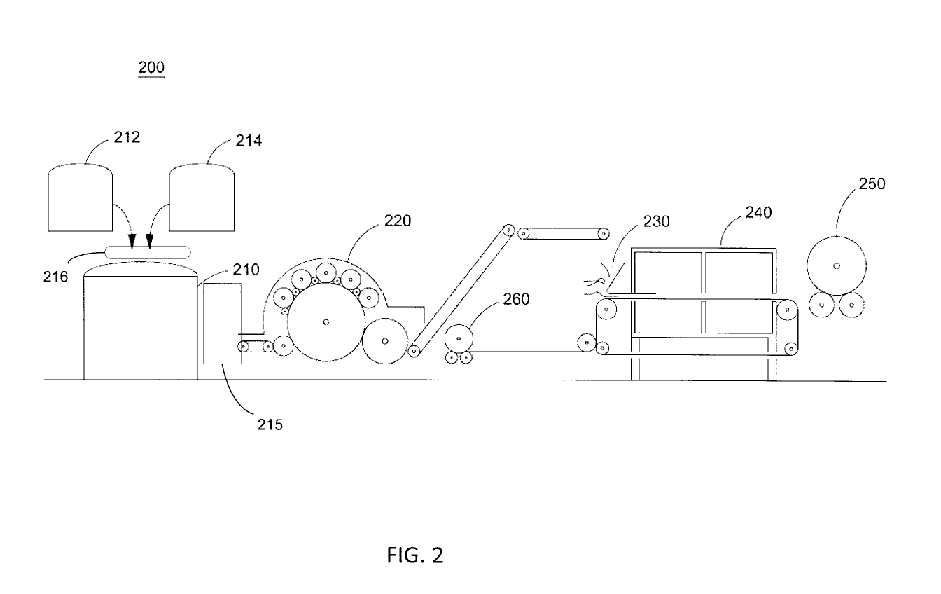

FIG. 2 is a diagram illustrating an example of a system 200 that may be used to make a foam fiber product, such as the foam fiber product 100 of FIG. 1. As shown in FIG. 2, the system 200 includes a mixing unit 210 in which the foam particles and the fiber strands are combined and mixed to distribute the foam particles with the fiber. According to an embodiment, the foam particles may be provisioned in a first containing unit 212, and the fiber in a second containing unit 214, where the containing units 212, 214 are hoppers. In some embodiments, multiple types of foams and/or fibers may be available, each of which has its own containing unit.

The desired fiber strands may be expelled from the fiber containing structure(s) 214 onto a conveyor 216 or other structure. A desired quantity of foam particles may be expelled from the foam containing structure(s) 212 onto the fiber. The conveyor 216 may deliver the foam and fiber to a mixing unit 210 in which the materials mixed with an auger or other mixing apparatus (not shown). A foam fiber mixture is the result of the foam particles and the fiber being combined.

The mixture may exit the mixing unit and enter a garnetting machine 215 that builds a foam fiber layer by lapping the fibers back and forth. Several layers of the foam fiber mixture may be laid down onto one another to increase the thickness.

As shown in FIG. 2, the system 200 may further include a carding machine 220, which receives the foam fiber layer and forms it into a carded web. The carding process aligns the fiber strands and foam particles into substantially parallel strands fiber strands interspersed with foam. This, the output is a foam fiber layer that includes a carded web of material. In an embodiment, the carding machine 220 includes plastic or metallic brushes or teeth that open, separate and align the fibers as the mixture moves through the machine.

A pleating machine 230 receives and forms the foam fiber carded web into the pleated structure 100 described above and shown in FIGS. 1A and 1B. The pleating machine 230 may be a vertical lap fiber processing unit, according to an embodiment. A Struto machine is one type of vertical lap fiber processing unit that may be used, although various other types of fiber processing units may be used.

With further reference to FIG. 2, an oven 240 may be an additional, optional component of the system 200. After the pleated foam fiber product is formed, the oven 240 applies heat to the product to bind together the pleats. The oven may apply heat at a temperature that is above the melting point of low-melt fibers in the mixture but below the melting point of non-low-melt fibers in the mixture and the melting or ignition point of the foam, so that the low-melt fibers become tacky and bind the non-low-melt (i.e., high melt) fibers together, while the high melt fibers and the foam remain structurally intact. Example temperature ranges of the oven may be, for example, between about 220° F. and about 385° F.

A winding mechanism 250 may be included to gather and wind the foam fiber product with pleats. If the pleated foam fiber product is heated to bind together the pleats, the pleated foam fiber product may be cooled prior to being gathered and wound by the winding mechanism 250.

Another optional component is a supporting layer introducer 260, which provides a supporting layer to be bonded to the bottom portion of the pleated foam fiber product. The material of the supporting layer may be based on the intended application or use of the foam fiber product. For example, a thin, non-woven material, such as polyester, may be used for some applications, while a thicker material may be more appropriate for other applications. The supporting layer introducer 260 may be positioned before the oven 240 as shown so that heat from the oven helps bond the foam-fiber to the supporting layer. Alternatively, the supporting layer introducer 260 may add the supporting layer after the oven 240 applies heat.

At one point during the process, the foam fiber product may be trimmed or cut into desired pieces. This may occur, for example, prior to or after application of the heat via the oven 240.

The fiber process, such as the vertical lap fiber process, may form the foam fiber carded web into the foam fiber product with pleats at a thickness of up to about 1-1.25 inches. If a thicker foam fiber product is desired, two or more separate sheets of the foam fiber product may be sealed or glued together. In an embodiment, the oven 240 may be used to bind together two or more separate sheets where the fiber 120 includes at least a portion of a low-melt fiber mixed with non-low-melt. In an alternate embodiment, a glue is used to bind together the two or more separate sheets. The glue may be any type of adhesive, such as those typically used in the upholstery industry, and may be a water-based, hot metal-based, or acetone-based adhesive depending on the composition and the intended application or use of the foam fiber product.

Alternatively, the pleating machine 230 may be omitted if a flatter product is desired, or it may be positioned after the oven 240.

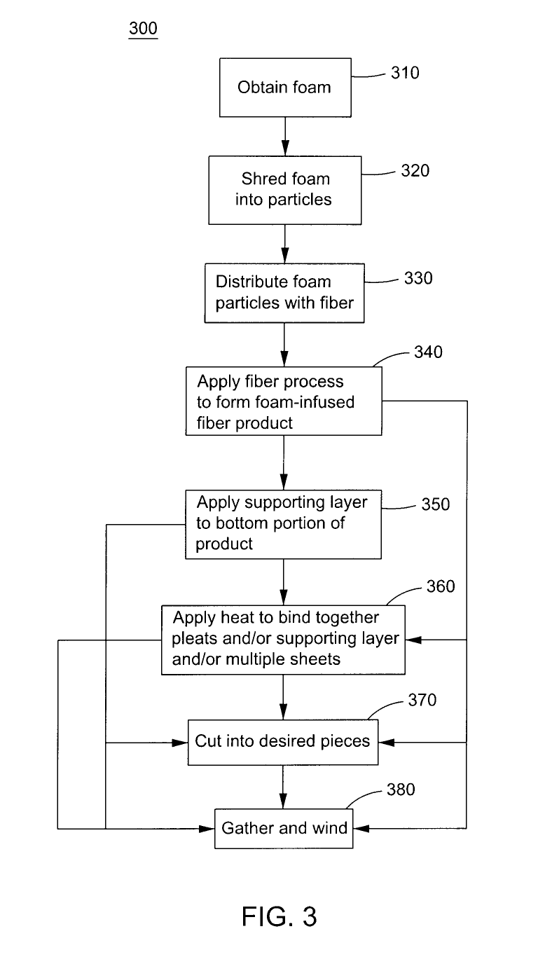

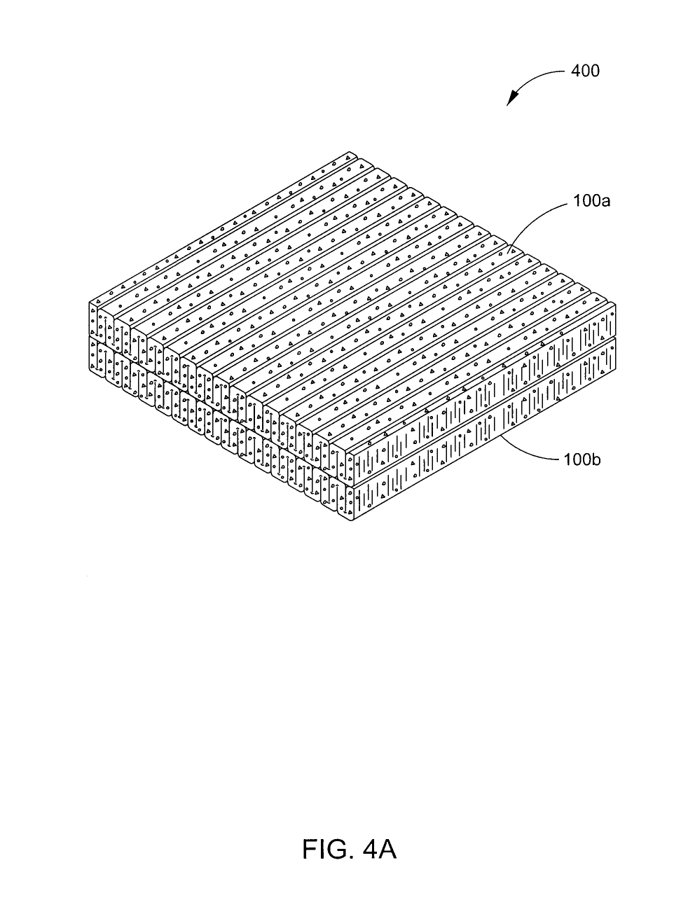

FIG. 3 is a flow chart illustrating a method 300 of making a foam fiber product, such as those described above. The components of the system 200 (see FIG. 2) may be used to make the foam fiber product, although other components and/or systems may also be utilized as the system 200 is just one example of a system capable of making the foam fiber product.

At 310, foam, such as excess scrap or new foam, is obtained, and at 320, the foam is shredded to form foam particles. Steps 310 and 320 may be optional, as a manufacturer may simply obtain the foam particles.

At 330, the foam particles are mixed to be distributed with fiber. The distribution is preferably an even distribution, although some variation is likely and acceptable due to the nature of the distribution process described above. The foam particles may be, for example, one or any combination of the following: gel foam, viscoelastic foam, polyurethane foam, memory foam, slow recovery foam, ground foam, latex foam, reflex foam, continuous foam, hyper-soft resilient foam, and hyper-soft high airflow viscoelastic foam. The fiber may be strands or other structural embodiments of one or any combination of the following: polyester, polypropylene, rubberized fiber, rayon, nylon, polyethylene, and cotton. In some embodiments, the fiber strands may be of a type that includes a structure that helps hold the foam in place, such as containment filaments. The foam particles and the fiber are not limited to these materials.

At 340, a fiber layer construction process is applied to the distribution of the foam particles and the fiber. The fiber layer construction process may include a first lapping process that laps the mixture into one or more layers, a carding process to separate and align the fibers into a continuous mat, and a second lapping process such as a vertical lap fiber process that forms a pleated structure. The fiber layer construction process forms the foam fiber mixture to a material comprised of a top portion and a bottom portion with a plurality of pleats extending between the top and bottom portions. Optionally, the outer rounded edges of the pleats form the top and bottom portions.

Following the application of the fiber layer construction process, various optional steps may be introduced. For example at 350, a supporting layer may be applied to the bottom portion of the foam fiber material. The supporting layer may be applied with an adhesive or with heat, for example.

At 360, heat may be applied to bind together the pleats of the foam fiber material, to bind the supporting layer to the bottom portion of the material, and/or to bind together multiple foam fiber mats to form a thickened product. Heat may be applied after the pleating 340 and supporting layer application 350 as shown, or before either or both of those steps.

At 370, the foam fiber product 100 may be cut or trimmed into desired portions.

At 380, the foam fiber product 100 may be gathered and wound. Optionally, a coating process may apply a coating to the material, such as a waterproof coating or similar substance.

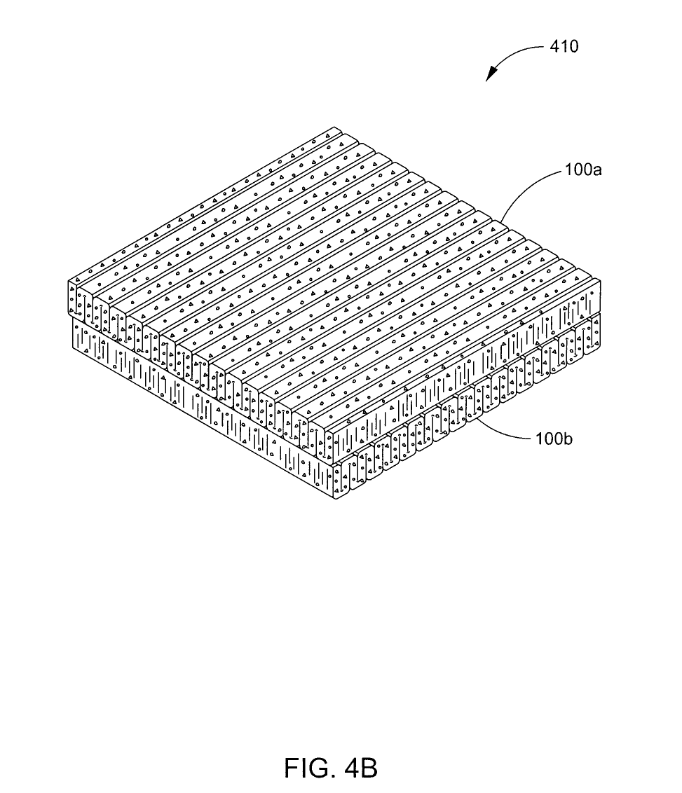

With reference to FIGS. 4A and 4B, diagrams illustrating a perspective view of a structure of thickened foam fiber products 400 and 410, according to embodiments, are provided. The thickened foam fiber products 400 and 410 shown in FIGS. 4A and 4B include two layers of foam fiber material (100a and 100b) that are joined together by, as described above, heat or glue, for example. In the embodiment shown in FIG. 4A, the thickened foam fiber product 400 includes the two foam fiber layers 100a and 100b oriented so that the pleats are parallel with respect to one another. In the embodiment shown in FIG. 4B, the pleats of the two foam fiber layers 100a and 100b are oriented perpendicularly with respect to one another to form the thickened foam fiber product 410.

More than two of the foam fiber layers may be joined together to create a product of a greater thickness. The thickened foam fiber product can include various layers of foam fiber materials, each with properties (e.g., compression of pleats, types of materials, density, overall thickness, etc.) that are similar or varying or a combination thereof.

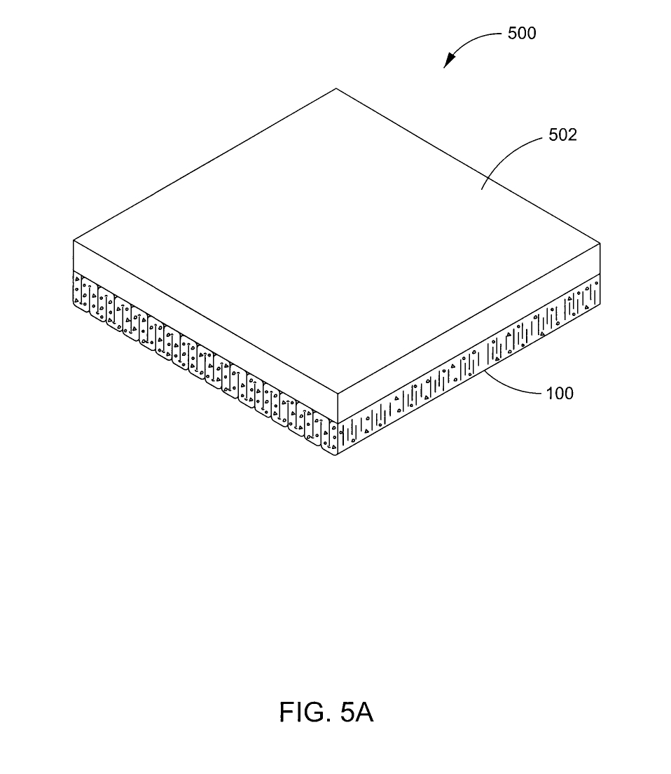

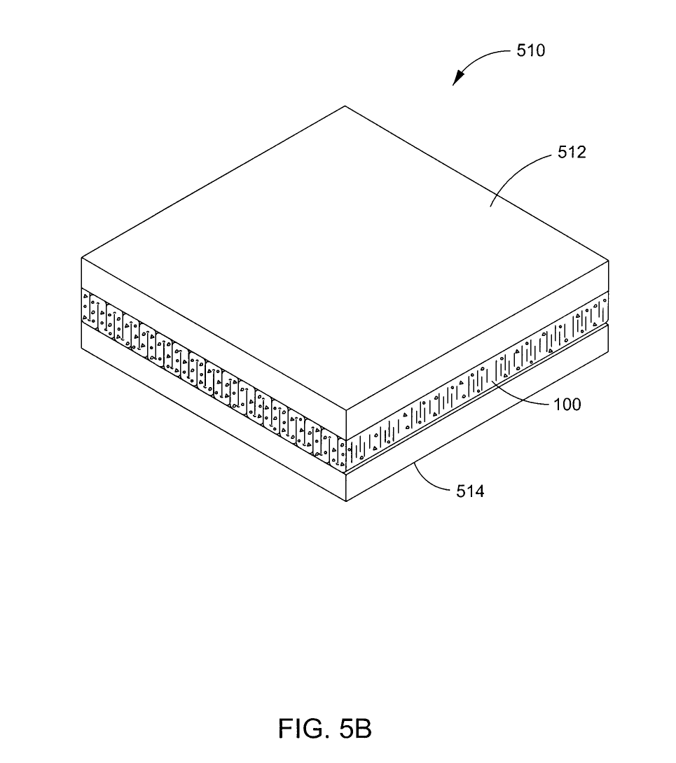

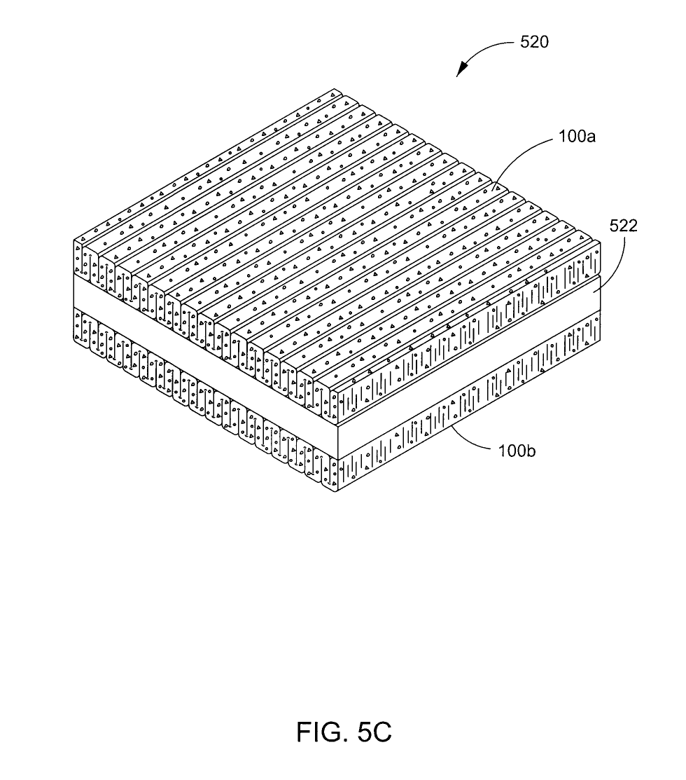

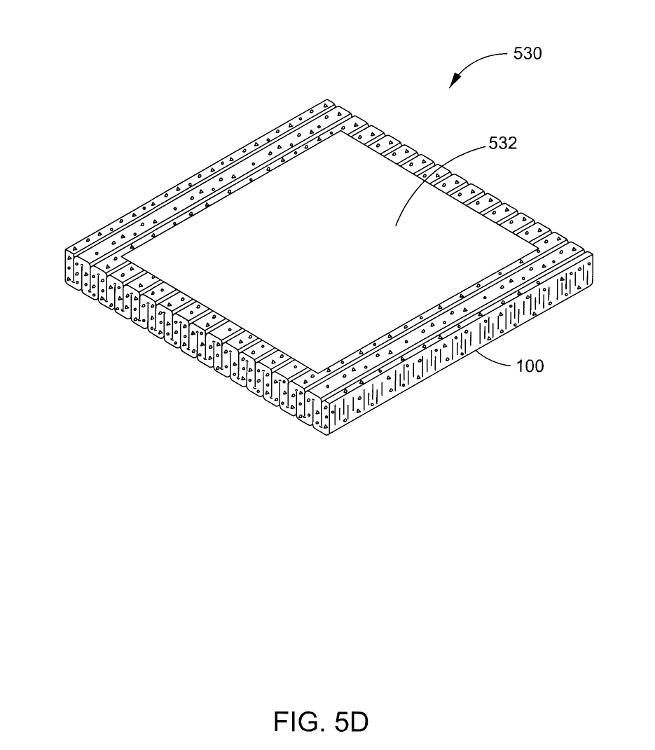

FIGS. 5A, 5B, 5C, and 5D are diagrams illustrating perspective views of various multi-layer products incorporating one or more foam fiber materials with other products that together may be used in various bedding products, including, mattresses, pillows, mattress toppers, seat cushions, and similar products. As used in this document, the term “bedding product” means any product intended to support at least part of a person at rest. The term includes, without limitation, mattresses, pillows, mattress toppers, seat cushions, and similar products. It also includes like items made of memory foam such as that used in mattresses and pillows, such as lumbar supports, back supports, gaming chairs, ottomans, chair pads, benches, and seats.

FIG. 5A is a perspective view of a bedding product 500 such as a mattress including a top or bottom layer 502 adhered to a foam fiber layer 100. FIG. 5B is a perspective view of a product 510 including a top layer 512 adhered to a foam fiber layer 100, which is adhered to a bottom layer 514. FIG. 5C is a perspective view of a product 520 including a top layer comprised of a foam fiber layer 100a adhered to a middle layer 522, which is adhered to a bottom layer comprised of a foam fiber layer 100b. FIG. 5D is a perspective view of a product 530 including a foam fiber layer 100 with an embedded layer 532 in the top portion. According to an embodiment, the embedded layer 532 is a gel layer. The embedded layer 532 may be set within a portion of the top portion of the foam fiber product 100 or may lay on top of the top portion. The embedded layer 532 may protrude out of or be level with the top portion of the foam fiber layer 100.

The non foam-fiber layers 502, 512, 514, 522, and 532 may be memory foam layers, gel-infused memory foam layers, fiber layers, or gel layers, for example. The various configurations 500, 510, 520, and 530 may be combined to form other desired configurations. For example, the product 530 may include a gel layer as the embedded layer 532 within the foam fiber layer 100, and this may be adhered to the product 500 of FIG. 5A in various arrangements (i.e., on the top layer 502 or on the foam fiber layer 100).

Moreover, in the various configurations 500, 510, 520, and 530, the foam fiber layer may be a thickened version including two or more layers of the foam fiber material, such as the thickened foam fiber products 400 and 410 of FIG. 4.

The various layers of the products 500, 510, 520, and 530 may be adhered with heat or glue or by molding or lamination processes. Alternately, the various layers of the products 500, 510, 520, and 530 need not be adhered but may simply rest on one another.

Once formed, the products may be shaped and used as various bedding products. For example, the structure of FIG. 5A may include be used as a mattress, mattress topper or pillow having a foam fiber layer 100 and a foam or gel-foam layer 502. In FIG. 5B, the foam fiber layer 100 of the bedding product may be sandwiched between two foam or gel-foam layers 512, 514. Alternatively, in FIG. 5C, a foam or gel-foam layer 522 of the bedding product may be sandwiched between two foam fiber layers 100a, 100b. In FIG. 5D, a foam or gel-foam layer 532 of a bedding product may be positioned within a foam fiber structure 100 having an opening that receives the foam/gel-foam layer so that the foam fiber structure surrounds the edges of the foam/gel-foam layer.

The term “foam” as used in this document means any type of air filled matrix structure including without limitation viscoelastic foams, polyurethane foam, memory foam, slow recovery foam, ground foam, latex foam, reflex foam, continuous foam, hyper-soft resilient foam, or hyper-soft high airflow viscoelastic foam such as that disclosed in U.S. Patent Application Publication No. 2005/0278852, which is hereby incorporated by reference. In some embodiments, the foam may be a hyper-soft high airflow viscoelastic foam. In particular embodiments, the foam may be a polyurethane foam created from a formulation comprising an isocyanate, a surfactant, and a polyol blend comprising a vegetable oil polyol as described in U.S. Pat. No. 7,700,661, which is hereby incorporated by reference. In further embodiments, the polyurethane foam may be made from a formulation comprising a polyol blend comprising a petrochemical polyol and a vegetable oil polyol, and an isocyanate blend comprising a 2, 4 toluene diisocyanate (TDI) isomer and a 2, 6 TDI isomer, wherein the ratio of petrochemical polyol to vegetable oil polyol in the polyol blend is about equal to the ratio of the 2, 4 TDI isomer to the 2, 6 TDI isomer in the isocyanate blend, as described in the '661 patent. In some embodiments, the foam may include further additives such as, without limitation, one or more activators, stabilizers, amines, colorants, dyes, pigments, chain-extending agents, surface-active agents (i.e., surfactants), fillers, and the like.

The term “gel” as used in this document means any liquid-extended polymer composition. In some aspects, the gel composition may contain a three-dimensional network of cross-linked molecular chains (gels), it or may merely behave as if it contained such a network (gelloids). Examples of gels used in aspects of the invention include, without limitation, oil-extended triblock copolymer compositions such as that disclosed in U.S. Pat. No. 3,485,787, U.S. Pat. No. 3,676,387, U.S. Pat. No. 3,827,999, U.S. Pat. No. 4,176,240, U.S. Pat. No. 4,259,540, U.S. Pat. No. 4,351,913, U.S. Pat. No. 4,432,607, U.S. Pat. No. 4,492,428, U.S. Pat. No. 4,497,538, U.S. Pat. No. 4,509,821, U.S. Pat. No. 4,709,982, U.S. Pat. No. 4,716,183, U.S. Pat. No. 4,833,193, U.S. Pat. No. 4,942,270, U.S. Pat. No. 5,149,736, U.S. Pat. No. 5,331,036, and U.S. Pat. No. 5,994,450; and thermoplastic elastomer gelatinous compositions such as that disclosed in U.S. Pat. No. 4,369,284, U.S. Pat. No. 4,618,213, U.S. Pat. No. 5,262,468, U.S. Pat. No. 5,508,334, U.S. Pat. No. 5,153,254, U.S. Pat. No. 5,334,646, U.S. Pat. No. 5,239,273, U.S. Pat. No. 5,475,890, and U.S. Pat. No. 5,336,708. Each of the patents listed above are hereby incorporated by reference. In particular embodiments, the gel comprises hydrogenated polymers comprising a plurality of covalently linked conjugated diene monomers, monoalkenylarene polymers or a mixture thereof. In some embodiments, the gel further comprises an additive. In further embodiments, the additive may be a plasticizer, a melt viscosity modifier, a tensile strength modifier, a shrinkage reducer, a plasticizer bleed modifier, a tack modifier, a foam facilitator, a flame retardant, or mixtures thereof. In an embodiment, the gel may comprise an elastomeric component comprising a triblock copolymer having the general configuration A-B-A as at least one of the elastomeric polymers, wherein A represents a crystalline polymer such as a monoalkenylarene polymer, including without limits, polystyrene and functionalized polystyrene, and B represents an elastomeric polymer such as poly(ethylene/butylene), hydrogenated poly(isoprene), hydrogenated poly(butadiene), hydrogenated poly(isoprene+butadiene), poly(ethylene/propylene), hydrogenated poly(ethylene/butylene+ethylene/propylene), or other crystalline polymers.

Embodiments include gel-foams comprising gel particles dispersed in foam. Thus, the term “foam” as used in this document includes various types of gel-foams. In further embodiments, the foam may be polyurethane foam. Polyurethane foam may be utilized by many industries such as furniture, construction, transportation, insulation, medical, and packaging and may be used as cushioning material in upholstered furnishings, mattresses, airline and automobile seating, or the like.

The term “fiber” as used in embodiments herein may be any suitable natural, recycled, or synthetic fiber for use in various padded products such as furniture and bedding products. Examples of fibers used in embodiments herein include, but are not limited to, polyester, polypropylene, rayon, nylon, polyethylene, cotton, rubberized fibers and any combination thereof.

This invention is not limited to the particular processes, compositions, or methodologies described, as these may vary. The terminology used in the description is for the purpose of describing the particular versions or embodiments only, and it is not intended to limit the scope of the present invention which will be limited only by the appended claims. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing in this document is to be construed as an admission that the invention is not entitled to antedate such disclosure by virtue of prior invention.

1. A method of forming a foam fiber product comprising:
distributing foam particles with fiber to produce a foam fiber mixture; and
applying a fiber layer construction process to the foam fiber mixture to form a foam fiber structure comprising a plurality of pleats.

2. The method of claim 1, wherein the foam particles comprise one or more of gel foam, viscoelastic foam, polyurethane foam, memory foam, slow recovery foam, ground foam, latex foam, reflex foam, continuous foam, hyper-soft resilient foam, or hyper-soft high airflow viscoelastic foam.

3. The method of claim 1, wherein the fiber comprises one or more of polyester, polypropylene, rubberized fiber, rayon, nylon, polyethylene, or cotton.

4. The method of claim 1 wherein applying the fiber layer construction process comprises applying a first lapping process to the mixture to form one or more lapped layers of foam fiber materials.

5. The method of claim 1, wherein applying the fiber layer construction process comprises processing the mixture by a carding machine to align the fibers in a foam fiber layer.

6. The method of claim 5, wherein the fiber layer construction process further comprises applying a vertical lap fiber process to form the pleats in the structure.

7. The method of claim 5, wherein the fiber comprises low melt fibers and high melt fibers, and the method further comprises applying heat to the structure at a temperature that is above a melting point of the low melt fibers and below a melting point of the high melt fibers so that the low melt fibers become tacky and bind the structure together.

8. The method of claim 1, further comprising:
binding the structure with one or more additional foam fiber pleated structures to form a thickened foam fiber product.

9. The method of claim 1, further comprising:
bonding a supporting layer to a base portion of the pleated foam fiber structure.

10. The method of claim 1, wherein:
the fiber layer construction process comprises:
applying a first lapping process to the mixture to form one or more lapped layers of foam fiber materials,
processing the lapped layers by a carding machine, and
applying a vertical lap fiber process to form the lapped layers into the pleated structure;
the fiber comprises low melt fibers and high melt fibers; and
the method further comprises applying heat to the structure at a temperature that is above a melting point of the low melt fibers and below a melting point of the high melt fibers so that the low melt fibers become tacky and bind the structure together.

11. A foam fiber product comprising:
a sheet comprising of foam particles distributed with fiber strands formed into plurality of pleats extending from a top portion to a bottom portion of the sheet.

12. The foam fiber product of claim 11, wherein the foam particles comprise one or more of gel foam, viscoelastic foam, polyurethane foam, memory foam, slow recovery foam, ground foam, latex foam, reflex foam, continuous foam, hyper-soft resilient foam, or hyper-soft high airflow viscoelastic foam.

13. The foam fiber product of claim 11, wherein the fiber comprises one or more of polyester, polypropylene, rubberized fiber, rayon, nylon, polyethylene, or cotton.

14. The foam fiber product of claim 11, wherein the plurality of pleats extend nearly perpendicularly from the top portion to the bottom portion.

15. The foam fiber product of claim 11, wherein the foam fiber product comprises about 20% to about 30% by volume of foam and about 70% to about 80% by volume of fiber.

16. A bedding product comprising a pleated layer structure comprising a mixture of foam and fiber strands.

17. The bedding product of claim 16, further comprising a non-foam-fiber layer attached to the pleated layer structure.

18. The bedding product of claim 16, wherein the product is an article selected from the group consisting of a mattress, pillow, lumbar support, back support, gaming chair, ottoman, and chair pad.
